(19) United States
(12) Patent Application Publication
(10) Pub. No.: US 2003/0172119 A1
(43) Pub. Date: Sep. 11, 2003

(54) Method and system for dynamically sending email notifications with attachments in different communication languages

(75) Inventors: Tejaswini Hosali, Durham, NC (US); William John Reilly, Cary, NC (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/092,319

(22) Filed: Mar. 6, 2002

(51) Int. Cl. G06F 15/16

(52) U.S. Cl. 709/206

(57) ABSTRACT

A method and system dynamically send a language-specific email and attachment, using for example, the Systems Applications and Products (SAP) workflow technology and Internet connectivity to provide customized messages and PDF attachments to any customer, worldwide, via the customer's Internet address. To this end, the system parses a document to retrieve variable data related to several destination languages. Then, based on the parsed variable data, the system selects the specific destination languages for the electronic message and attachment, and sends the same in the selected destination languages to the various destination addresses. Concurrently, the system may also send the retrieved variable data to all or some of the destination addresses.

### FIELD OF THE INVENTION

The present invention relates in general to the field of data management, and particularly to a workflow. More specifically, this invention relates to a system and associated method for the implementation of a dynamic email notification with attachments in different languages.

### BACKGROUND OF THE INVENTION

“Email” is generally defined as a store-and-forward process of conveying messages electronically over a computer network. It is a quick, dependable, relatively inexpensive, and extensively accessible communication means. Email attachments, such as documents, graphics, spreadsheets, presentations, and applications render emails more popular and cost effective.

In recent years, email has immensely impacted conventional personal and business communication systems. Because email can include attachments, it has started to compete with faxes, postal services, and couriers. It has emerged as f a vital part of daily business operations. It is expected that email will become a necessary tool for conducting daily business. In effect, email has attained a critical status in the continued success of the enterprise with billions of emails circulating the Internet daily.

A dynamic email notification is a specialized, en masse category of email designed to reach a large number of administrators, customers, and/or vendors, to purvey notices, such as corporate news bulletins, changes in sales orders, events of item deletions, and critical news bulletins or messages about new product offerings.

However, with the widespread international use of the Internet and email, it has become necessary to concurrently address versatile audiences in several countries, or even the entire world. To this end, the notices need to be language-specific to the target audience.

A Systems Applications and Products (SAP) workflow provides the infrastructure and tools that enable business processes and human resources management more efficiently. It routes data quickly to the proper individual, even if the person is in a different office or country, and facilitates the administrators' task of dealing with transactions and forwarding them through the chain of command.

The SAP workflow enables business processes to be defined according to organizational standards and company-specific procedures. The workflow may be monitored and information on the current status of a task or work item may be viewed at any time. Work load distribution and identifying capacity problems or work overload can be identified before developing into a problem. With the SAP workflow, administrators can approve transactions, even partially, in a uniform process.

Whenever changes are made to the organization, they are automatically reflected in the workflow. Since the SAP workflow is position-based rather than person-based, workflow routes do not need to be updated every time an employee is promoted or changes jobs. The SAP workflow could be used to increase the efficiency of the company's sales organization, purchasing department, and human resources group, by implementing a single routing structure for all processes, across all applications, throughout the company worldwide.

### SUMMARY OF THE INVENTION

The present invention meets the support requirement needed to send a language-specific email and attachments to any worldwide email address via the Internet. To this end, the system and associated method of this invention can utilize, for example, the Systems Applications and Products (SAP) workflow technology and Internet connectivity to provide customized messages and PDF attachments to any customer, worldwide, via the customer's Internet address.

PDF is an acronym for portable document format which is designed to be portable across computer platforms. PDF documents are typically invariant in that they cannot generally be altered without the source document. The communications are sent in the language preferred by the customer.

One implementation of the present invention is a process where, for example, a sale order is created or changed that includes ordering certain products. As an illustrative example, a certain number of computers are ordered, and an installation service document need to be sent electronically, whenever the ordered products have associated installation service agreements, which are also represented as products in sales order. Typically, customers provide their email addresses while entering the sales order, which are in turn entered on a particular text field in the sales order line items. The customer can enter different email addresses for different line items. An email is sent to an address specified in the sale order line item text field. Certain sections of the email text are pre-formatted, while other sections are dynamic, i.e., based on the information on the sale order, such as: the Sales Order Number, Line Item Number, Email Address, Material, Material Description, and Quantity, and so forth.

A PDF file, or another distributable file that is proper for use as an attachment, with all the information regarding the agreement aspects of the installation service (or “Install Service”) is sent as an attachment to the email message. The text of the email and the attachment are sent in the appropriate communication language of the Install-At or Ship-To customer field (in a desired order of preference).

The present system and method achieve several advantages, among which are the following: Immediate customer receipt of the Install Service information; automated multi-language specific communication with one worldwide design/implementation; and improved worldwide Internet communications.

### BRIEF DESCRIPTION OF THE DRAWINGS

The above and further objects, features and advantages of invention will become clearer from the more detailed description read in conjunction with the following drawings, in which:

FIG. 1 is a schematic illustration of an exemplary operating environment in which a system and method for routing dynamic email notification with attachments may be used according to the present invention;

FIG. 2 is a process flow chart that depicts a method of parsing, sorting, and storing unique email addresses from inbound communication, using the system of FIG. 1; and

FIG. 3 is a process flow chart that depicts a method of dynamically forking and routing messages with language-specific attachments to appropriate email addresses, using the system of FIG. 1.

### DETAILED DESCRIPTION OF PREFERRED EMBODIMENTS

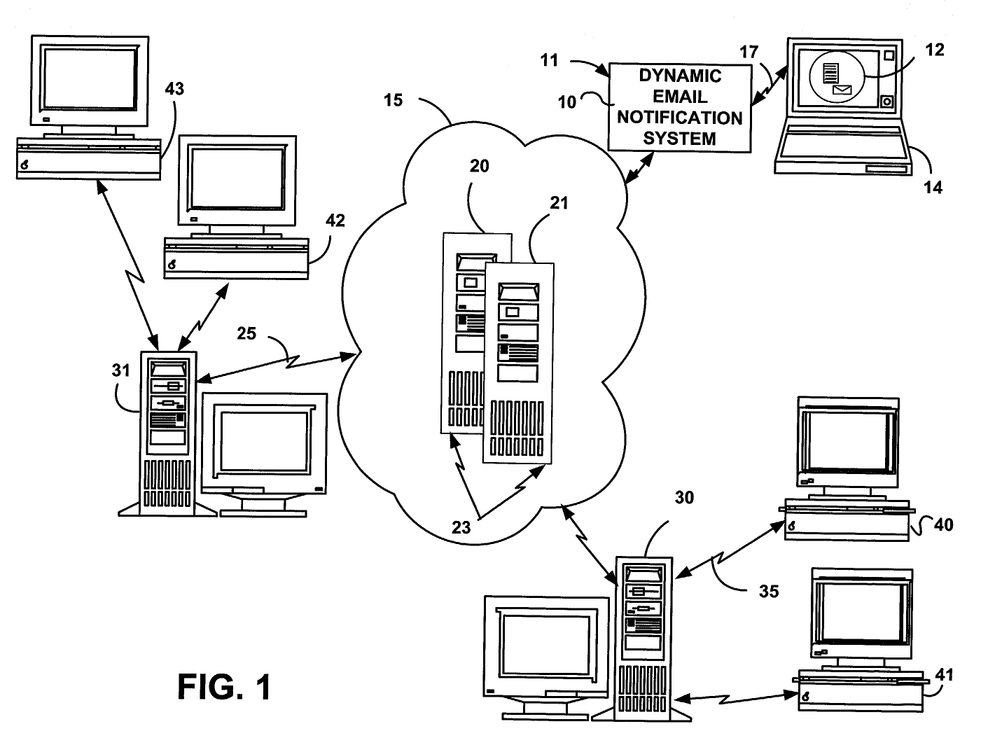

FIG. 1 portrays an exemplary overall environment in which a dynamic email notification system 10 that resides, for example, on an application server 11, routes dynamic email notification with an attachment 12 according to the present invention. Attachment 12 may also be referred to as an enclosure, and can be, for example, one or more files that are added to an email. Files can be readily attached through almost any available email program, or a programmatic interface.

A client computer 14 includes a software or computer program product that typically provides connection to the Internet 15. While the system 10 will be described in connection with the World Wide Web or the Internet, it should be clear that the present invention can also be used with an Intranet and/or any other network.

In this example, the email author as represented by computer 14, accesses the Internet 15 remotely through an Internet Message Access Protocol (IMAP) 17. IMAP 17 is a method of sending or accessing bulletin board or email messages stored on a remote server.

Unlike the case with POP style mail access protocol, an email stored on an IMAP server can be accessed from a workstation at the office, a desktop computer at home, or a notebook computer while traveling, without transferring files or messages back and forth between computers.

The cloud-like communication network, which is also referred to as the Internet 15, is comprised of communication lines, switches, and gateways that connect servers, such as servers 20, 21, to email servers such as email servers 30, 31. The servers 20, 21 and the email servers 30, 31 provide communication access to the Internet 15. Email clients and Internet users are represented by a variety of computers such as computers 40, 41, and can send and retrieve messages through email servers, i.e., 30, 31.

The host server 20 handles requests from other computers on the network 15. As used herein, the term server is interchangeably applied to a host computer on a network and to the software that makes the process of serving information possible. The server 20 is connected to the network 25 via a communications link such as a telephone, cable, or satellite link. The servers 20, 21, 30, and 31 can be connected via high speed Internet network lines to other computers and gateways.

Servers 20, 21 utilize protocols such as SMTP 23 (Simple Mail Transfer Protocol) to communicate messages. SMTP is a server-to-server protocol and the Internet's standard network management protocol for the transfer of email messages.

The email servers 30, 31 are usually personal computers on the network 15, which send and receive emails for all clients on the network 15. Email servers 30, 31 employ MAPI 25 to route emails. MAPI (Messaging Application Programming Interface) is an Application Programming Interface separating client from server functionality and allowing numerous applications, such as mail front ends, spreadsheets, and word processors to access the messaging capabilities of back-end mail servers.

In one example, a dynamic email, including a message and an attachment 12, arrive to client computer's (e.g., 40) mailbox, a single owner system for email message storage. As used herein, “dynamic” refers to the non-static (or fixed) content of the email.

The mailboxes of client computers 41, 42, and 43 also receive the same dynamic email. Each client computer retrieves the email through a Post Office Protocol (POP). There are currently three versions of this protocol: POP1, POP2, and POP3.

The host server 20 and email server 30, transparently to the user, continuously or periodically operate in the background. While in this illustration the application server(s) 11 programmatically sends the email to the computer 40, it should be clear that the process may be reversed.

The advantages of the dynamic email notification system 10 are numerous, among which are the following:

Immediate customer receipt of important business documents, such as the Installation Service information agreement.

Automated multi-language specific communication with one world wide design/implementation.

World Wide Internet communication using the existing infrastructure.

Customer satisfaction of receiving necessary information on a timely basis, in the communication language that the customer requested.

Many different dynamic e-mails, in different languages, can be sent to multiple different e-mail addresses for one event instance. The necessary and relevant information for the particular recipient, are populated in the document and sent to the requested address for the particular type of material(s).

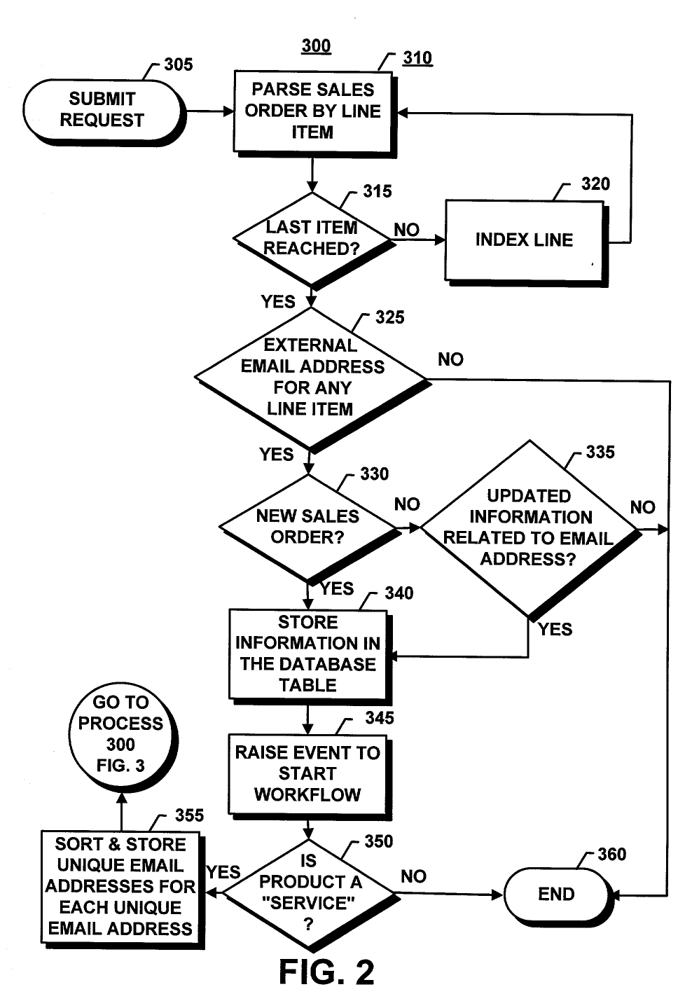

Turning now to FIG. 2, it illustrates a process flow chart that depicts a method 300 for parsing, sorting, and storing unique email addresses from inbound communication, using the dynamic email notification system 10 of FIG. 1. Process 300 starts at block 305 where a request is submitted. In the present example, and solely for the purpose of illustration, the request is the creation of a “Sales Order” by posting an Intermediate Document.

At block 310, the Sales Order is analyzed according to predetermined rules or specifications. Parsing is done by line item. Information, such as Customer Number or Customer email address, is extracted.

At decision block 315, the system 10 checks if the last item of the Sales Order is reached. If not, method 300 continues to block 320 and indexes the Sales Order line item pointer, and then returns to block 310 to proceed as described above.

If it is determined at decision step 315 that the last item of the Sales Order has been reached, method 300 proceeds to decision block 325, and checks the Sales Order's line items for external email addresses. If none exists, method 300 proceeds to the end block 360.

If, however, the line item of the Sales Order contains an email address, method 300 continues to decision block 330. The email address specified in the Sales Order line item will receive the email notification with the attachment (in PDF or another format).

At decision block 330, method 300 checks if the Sales Order is new. If not, method 300 proceeds to decision block 335. However, if the Sales Order is new, method 300 continues to decision block 340. At decision block 335, method 300 parses the information at hand to check if the updated information is related to the email address. If not, method 300 proceeds to the end block 360. However, if it is determined at decision step 335 that the updated information is related to the email address, then method 300 deems the finding worthy of logging and continues to block 340.

At block 340, the new Sales Order or the updated information and the external email address are stored in a custom database table. The custom database table is created with the required fields so that relevant data fields from the Sales Order can be stored. This prevents any performance implication on the Sales Order processing, and makes it easy to repeatedly reroute the email notification without impacting the Sales Order and other performance critical database tables. Method 300 then continues to block 345, where, based on the database entry, the event to start the workflow is raised programmatically.

At decision block 350, method 300 determines whether or not the product is a service. If the product is determined to be a service, method 300 continues to block 355. Otherwise, method 300 proceeds to the end block 360. This is another point where performance of the critical order processing process is enhanced, since to verify whether the product is a service oriented or not is quite performance intensive task. The task is performed outside the order processing process, as part of the workflow.

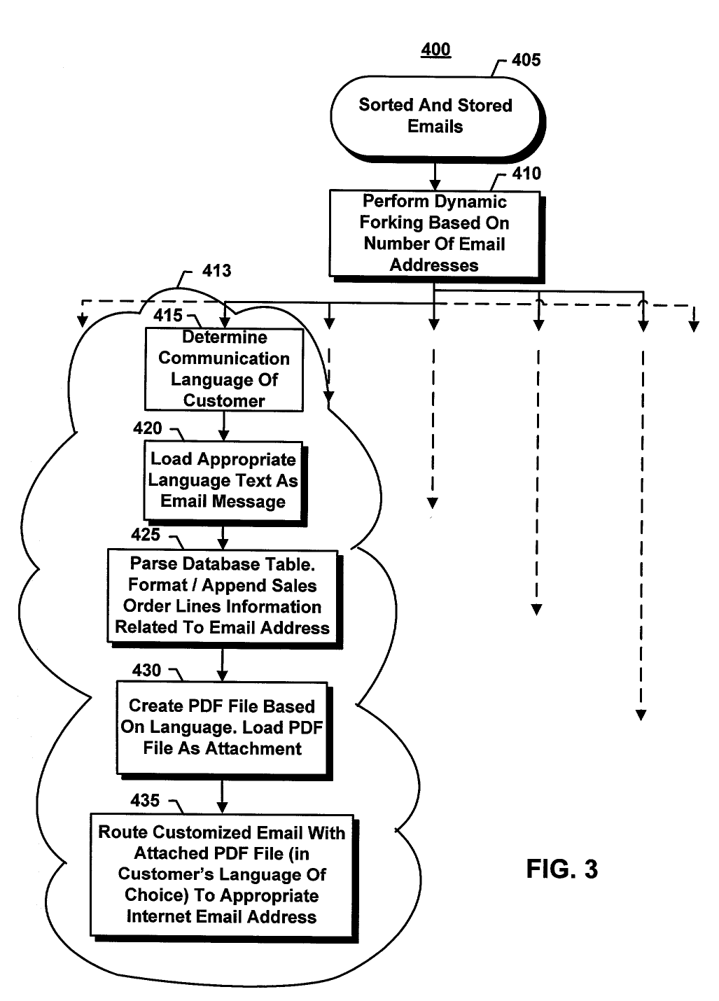

At block 355, unique emails are first sorted then stored. This is done for each record (or object). When the last record's email has been sorted and stored, method 300 continues to process 400 of FIG. 3. FIG. 3 is a process flow chart that depicts a method 400 for dynamically forking and routing messages with language-specific attachments to appropriate email addresses, using the system 10.

Method 400 is an extension of process 300, and starts at block 405, with unique email addresses that were sorted and stored as described at block 355 of FIG. 2. At block 410, process 400 performs dynamic forking based on the number of unique email addresses it gathered at block 355 of process 300. The number of unique email addresses determines the number of dynamic tasks started.

The cloud-like formation labeled 413 is a sample representation of dynamic task processing throughout method 400. Different exemplary workflow paths are illustrated as dotted lines. At the end of each dotted line, steps similar to those at blocks 415 through 435 are implemented, though they are not illustrated.

At block 415, and based on information extracted from the Sales Order, the customer's preferred language of communication is determined. This is accomplished by examining a customer field in the Sales Order request, and then searching the customer master database to get the appropriate country and the language of the associated country of the customer. The customer's preferred language of communication can also be determined from other resources.

At block 420, the appropriate text is loaded based on the preferred language of communication as determined at block 415. The pre-formatted text that needs to be sent as part of the email in the customer's communication languages are stored in language specific custom database tables. A loading program loads the pre-formatted text and the PDF attachment file into appropriate an database table based on language. For example, English text and English PDF file are stored in two database tables specified to store the English text and PDF file, which is done once or as necessary using the custom loading program.

At block 425, the database table is parsed. The Sales Order lines information pertaining to the addressee's email are formatted and appended. The sales order number, line item number, the material, the email address and product description are stored in a custom database table.

At block 430, a reply message is created in the customer's preferred communication language. A program or code reads the pre-formatted text from the specific language database table, appends the relevant information like Sales Order number, material number, and description from the custom database table. This program further reads the PDF file from the language specific table to create the final email text that needs to be sent to the email address specified. At block 435, the customized email along with the attached PDF file (in the customer's preferred communication language) is routed to the appropriate Internet email address.

It is to be understood that the specific embodiments of the present invention that are described herein are merely illustrative of certain applications of the principles of the present invention. Numerous modifications may be made without departing from the scope of the invention.

What is claimed is:

1. A method of sending a language-specific electronic message and corresponding attachment to at least one destination address in at least one destination language, comprising:
parsing a document to retrieve variable data related to the at least one destination language;
based on parsed variable data, selecting a specific destination language for the electronic message and attachment to be sent to the at least one destination address;
sending the electronic message and the attachment in the specific destination language to the at least one destination address; and
concurrently and selectively sending retrieved variable data to the at least one destination address.

2. The method of claim 1, wherein sending the electronic message and attachment includes sending the electronic message and attachment to at least two different destination addresses in at least two different languages.

3. The method of claim 2, wherein selecting the specific destination language includes verifying the specific destination language based on a destination country of shipment.

4. The method of claim 2, wherein selecting the specific destination language includes verifying the specific destination language based on a destination country in which a software program will be installed.

5. The method of claim 2, wherein selecting the specific destination language includes verifying the specific destination language based on a communication language exchanged with the at least one destination address.

6. The method of claim 2, wherein selecting the specific destination language includes verifying the specific destination language based on a preferred language from the at least one destination address.

7. The method of claim 2, wherein selecting the specific destination language includes selecting a default language.

8. The method of claim 7, wherein selecting the specific destination language includes selecting a default language of a destination country.

9. The method of claim 7, wherein the default language is English.

10. The method of claim 2, wherein selecting the specific destination language includes communicating with a destination computer.

11. The method of claim 2, wherein sending the electronic message and the attachment includes selectively sending the electronic message and the attachment based on any one or more of: a product type, a requirement for service, a customer instruction, and registration information.

12. The method of claim 2, wherein the attachment includes a document.

13. The method of claim 2, wherein the attachment includes a pdf formatted document.

14. The method of claim 2, wherein parsing the document is triggered by a receipt of any one or more of: a sale order, a request for information, an inquiry, and a quote.

15. The method of claim 2, wherein selecting the specific destination language includes querying the document for the specific destination language.

16. The method of claim 2, wherein the electronic message includes an email.

17. The method of claim 16, wherein the at least one destination address includes an Internet address.

18. A computer program for sending a language-specific electronic message and corresponding attachment to at least one destination address in at least one destination language, comprising:
a first set of program instructions for parsing a document to retrieve variable data related to the at least one destination language;
a second set of program instructions for selecting a specific destination language for the electronic message and attachment to be sent to the at least one destination address, as a function of on parsed variable data; and
a third set of program instructions for sending the electronic message and the attachment in the specific destination language to the at least one destination address, and for concurrently and selectively sending retrieved variable data to the at least one destination address.

19. The computer program of claim 18, wherein the third set of program instructions cause the electronic message and attachment to be sent to at least two different destination addresses in at least two different languages.

20. The computer program of claim 19, wherein the second set of program instructions verifies the specific destination language based on a destination country of shipment.

21. The computer program of claim 19, wherein the second set of program instructions verifies the specific destination language based on a destination country in which a software program will be installed.

22. The computer program of claim 19, wherein the second set of program instructions verifies the specific destination language based on a communication language exchanged with the at least one destination address.

23. The computer program of claim 19, wherein the second set of program instructions verifies the specific destination language based on a preferred language from the at least one destination address.

24. The computer program of claim 19, wherein the second set of program instructions verifies the specific destination language by selecting a default language.

25. The computer program of claim 24, wherein the second set of program instructions verifies the specific destination language by selecting a default language of a destination country.

26. The computer program of claim 24, wherein the default language is English.

27. The computer program of claim 19, wherein the third set of program instructions sends the electronic message and the attachment based on any one or more of: a product type, a requirement for service, a customer instruction, and registration information.

28. The computer program of claim 19, wherein the attachment includes a document.

29. The computer program of claim 19, wherein the attachment includes a pdf formatted document.

30. The computer program of claim 19, wherein the first set of program instructions parse the document based on a triggering event.

31. The computer program of claim 30, wherein the triggering event is any one or more of: a sale order, a request for information, an inquiry, and a quote.

32. The computer program of claim 19, wherein the electronic message includes an email.

33. The computer program of claim 32, wherein the at least one destination address includes an Internet address.

34. A computer program for sending a language-specific electronic message and corresponding attachment to at least one destination address in at least one destination language, comprising:
means for parsing a document to retrieve variable data related to the at least one destination language;
means for selecting a specific destination language for the electronic message and attachment to be sent to the at least one destination address, as a function of on parsed variable data; and
means for sending the electronic message and the attachment in the specific destination language to the at least one destination address, and for concurrently and selectively sending retrieved variable data to the at least one destination address.
